(19) United States
(12) Patent Application Publication
(10) Pub. No.: US 2010/0040750 A1
(43) Pub. Date: Feb. 18, 2010

(54) METHOD AND APPARATUS TO PRODUCE A FRIED FOOD PRODUCT HAVING A REDUCED LEVEL OF FAT AND ACRYLAMIDE

(76) Inventors: Kimberly Nicole Assaad, Dallas, TX (US); Wilfred Marcellien Bourg, JR., Melissa, TX (US); Joseph H. Gold, Dallas, TX (US); Christopher James Koh, Southlake, TX (US)

Correspondence Address: CARSTENS & CAHOON, LLP, P O BOX 802334, DALLAS, TX, 75380, US

(21) Appl. No.: 12/190,662

(22) Filed: Aug. 13, 2008

(51) Int. Cl. A23L 1/01

(52) U.S. Cl. 426/438; 99/404

(57) ABSTRACT

Disclosed is an improved process and apparatus for producing low oil fried food products having less than 30 percent by weight oil based on the total weight of an unseasoned chip and a reduced level of acrylamide. The process discloses simultaneously contacting the par-fried food with a steam knife and a steam sweep.

### BACKGROUND OF THE INVENTION

1. Technical Field

The present invention relates to an improved method for producing a low oil content potato chip having a reduced level of acrylamide. More specifically, the present invention relates to a method whereby moisture content, oil content, and acrylamide levels are controlled in a unique combination of unit operations.

2. Description of Related Art

Conventional potato chip products are prepared by the basic steps of slicing peeled, raw potatoes, water washing the slices to remove surface starch and frying the potato slices in hot oil until a moisture content of about 1% to 2% by weight is achieved. The fried slices are then salted or seasoned and packaged.

Raw potato slices normally have moisture contents from 75% to 85% by weight depending on the type of potato and the environmental growing conditions. When potato slices are fried in hot oil, the moisture present boils. This results in burst cell walls and the formation of holes and voids which allow for oil absorption into the potato slices yielding, oil contents ranging from 30% to 45% by weight.

The oil content of potato chips is important for many reasons. Most important is its contribution to the overall organoleptic desirability of potato chips, however from the standpoint of good nutrition, it is desirable sometimes to maintain a low level of oil or fat in chips. Further, too high an oil content renders the chips greasy or oily and hence less desirable to consumers. On the other hand, it is possible to make chips so low in oil that they lack flavor and seem harsh in texture. A happy medium can be achieved by reducing the oil content in a chip so that the objectives of using less oil is met and consumers interested in reducing their intake of both fats and calories can be satisfied with an organoleptically pleasing snack food.

Numerous attempts have been made in the prior art to reduce the oil content in potato chips. Some attempts involve pre-treating the potato slices prior to frying. Other attempts involve treating the chips after frying, and some attempts use both pre- and post-treatments. However, past attempts at producing lower oil content chips are either expensive, use technology that requires longer than desirable deoiling dwell time, or have failed to maintain the desired organoleptical properties such as taste and texture that have become familiar to consumers of traditional potato chips having higher fat or oil contents.

For example, U.S. Pat. No. 4,749,579 teaches a process for producing potato chips having a fat content lower than 32% by weight. The '579 Patent discloses a pre-treatment process whereby potato slices are washed in a salt solution. The potato slices are dried and pre-heated with infrared radiation prior to being sent to the fryer. This process however, discloses a maximum reduction of oil content of about 32%, by disclosing a potato chip having a fat content of 26% to 32% by weight compared with a prior art oil content of 38%. It is desirable, however, to reduce oil contents by at least a third. Further, the '579 Patent fails to disclose a finished product moisture content or a means to control the moisture content independent of oil content.

Another prior art attempt for making a low oil potato chip by pre-fry treatment is disclosed by U.S. Pat. No. 4,917,919, which teaches coating a potato chip with an aqueous, polyvinylpyrrolidone. Unfortunately, the moisture content of the finished product is about 4% by weight, raising concerns of shelf stability.

U.S. Pat. No. 4,933,199, assigned to the same Assignee as the present invention, involves treating a fried potato chip in a de-oiling unit to lower the oil content and the moisture of the chip and then further treating the chip in a dehydrating unit to lower the moisture content of the chip. Unfortunately, oil content cannot be lowered without significantly dehydrating the chip.

Similarly, U.S. Pat. No. 4,721,625 uses a post-fry saturated steam treatment to reduce the oil content of the potato slices. A saturated steam blasting process, however, generally results in a pick up of moisture by the cooked slices due to condensation. As a result, the cooked slices require a subsequent drying unit operation. As previously indicated, this subsequent drying operation involves substantial economic capital and operating outlays.

Another prior art solution to making a low oil potato chip is illustrated by U.S. Pat. No. 4,537,786, also assigned to the same Assignee as the present invention. The '786 Patent teaches that thicker than normal slicing can reduce oil uptake during frying. The '786 Patent process discloses: frying potato slices in oil at a lower than normal temperature of between about 280° F. and 320° F., removing the potato slices from the fryer when the moisture content is about 3% to about 15% by weight, orienting the potato slices on edge, and contacting the fried potato slices for about 1 to about 10 minutes with.a stream of hot air. This hot air removes the excess oil as well as finishes cooking the chip. However, hot air tends to accelerate oxidation of the oil reducing shelf life dramatically.

Another prior art solution for a low oil potato chip is disclosed in U.S. Pat. No. 4,277,510, a process for making low oil potato chips by drying the slices in a monolayer, contacting the resultant dried potato slices with steam, and frying the steam-treated potato slices. Unfortunately, according to U.S. Pat. No. 4,721,625 (discussed above), the pre-drying of the product in the '510 Patent results in a glassy texture, case hardened product that has a raw, green flavor, which is different in taste and texture from regularly fried potato chips.

United States Patent Application Publication No. 2006/088633, assigned to the same assignee as the present invention, discloses using a single unit operation as both a deoiler and a dehydrator. Potato chips exiting a fryer take about 30 seconds to be conveyed to the deoiler.

One drawback of prior art deoiling methods is that the deoiler has the potential to produce higher levels of acrylamide because of tile exposure to high temperature superheated steam for dwell times up to 120 seconds. Consequently, a need exists for a process that enables the production of a fried food product such as a potato chip that has lower levels of oil and acrylamide than a traditionally fried food product, but that retains desirable organoleptical properties similar to traditional potato chips.

### SUMMARY OF THE INVENTION

The proposed invention provides an apparatus and method for making a fried food product having a reduced level of fat and acrylamide. In one aspect, a food product is fried in hot oil to a moisture content of about 2% to about 12%. the par-fried food product is removed from the hot oil and contacted with a flow of superheated steam. The flow of superheated steam is enhanced by positive pressure supplied by a steam knife above the bed of par-fried food product and by negative pressure supplied by a steam sweep below the bed of par-fried food product. In one aspect, the invention is directed towards a fryer having a perforated endless belt conveyor exiting the fryer and a steam knife positioned above the conveyor with a steam sweep positioned beneath the conveyor.

Other aspects, embodiments and features of the invention will become apparent from the following detailed description of the invention when considered in conjunction with the accompanying drawings. The accompanying figures are schematic and are not intended to be drawn to scale. In the figures, each identical, or substantially similar component that is illustrated in various figures is represented by a single numeral or notation. For purposes of clarity, not every component is labeled in every figure. Nor is every component of each embodiment of the invention shown where illustration is not necessary to allow those of ordinary skill in the art to understand the invention. All patent applications and patents incorporated herein by reference are incorporated by reference in their entirety. In case of conflict, the present specification, including definitions, will control.

### BRIEF DESCRIPTION OF THE DRAWINGS

The novel features believed characteristic of the invention are set forth in the appended claims. The invention itself, however, as well as a preferred mode of use, further objectives and advantages thereof, will be best understood by reference to the following detailed description of illustrative embodiments when read in conjunction with the accompanying drawings, wherein:

FIG. 1 is a schematic representation of one embodiment of an apparatus that can be used to practice the method of this invention;

FIG. 2a is a perspective view of the steam knife and associated piping in accordance with one embodiment of the present invention.

FIG. 2b is a front cross sectional view of the steam knife depicted in FIG. 2a;

FIG. 2c is a side view of the steam knife depicted in FIG. 2a;

FIG. 3a is a perspective view of the steam sweep in accordance with one embodiment of the present invention; and

FIG. 3b is a cross sectional side view of the steam sweep depicted in FIG. 3a.

### DETAILED DESCRIPTION

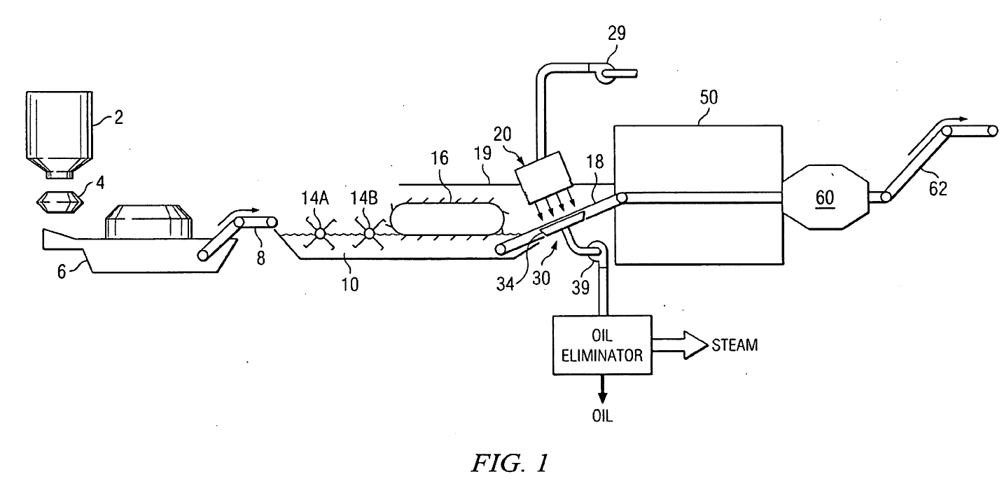

An embodiment of the innovative invention will now be described with reference to FIG. 1. Whole potatoes stored in hopper 2 are dispensed into a slicing apparatus 4 which drops potato slices into a water wash 6.

In one embodiment, the water wash 6 comprises a brine solution containing between about 1% to about 6% by weight of salt (NaCl) and more preferably between about 1.0% to about 4.5%. Brine solutions above 6% by weight tend to result in very salty flavors. It has been found that a residence time of between about 2 seconds and about 20 seconds, and more preferably about 6 seconds in a brine solution is sufficient for the potato slices of this invention. In one embodiment, the water wash 6 comprises a process volume enabling the brine solution to have full surface contact with the potato slices. The slices are removed from the water wash 6 by an endless belt conveyor 8 and deposited in frying oil contained within a fryer 10.

In an alternative embodiment, the water wash 6 does not contain a brine solution and a brine solution is sprayed on the potato slices after exiting the water wash 6 while on a conveyor belt 8. In one embodiment, the potato slices, after a brineless water wash, enter a brine solution before being routed to the fryer 10. In one embodiment no brine is used. The endless belt conveyor 8 can be designed as a drain conveyor to allow excess wash water or brine to drain from the slices. In one embodiment, an air knife (not shown) can be mounted above the endless belt conveyor 8 and a vacuum suction device (not shown) can be mounted underneath the endless belt conveyor 8 to aid in removal of excess moisture. The frying oil entering the fryer is maintained at an initial temperature between about 320° F. to about 380° F. more preferably between about 335° F. and about 370° F. Any conventional frying medium can be used in accordance with various embodiments of the present invention, including frying mediums with digestible and/or non-digestible oils. In one embodiment, the fryer is a continuous single flow or multizone fryer which utilizes devices such as paddle wheels, 14A and 14B, and a submergible conveyor belt 16 to control the flow of potato slices through the fryer 10.

Because the present invention can be applicable to foods other than sliced potatoes, the invention will now be described generally as pertaining to food pieces. Once the potato slices or food pieces have been fried to a water content of between about 2% to about 12% by weight or more preferably between about 2.5% and about 8% by weight, the food pieces are removed from the fryer by a perforated endless belt conveyor 18. If the food pieces are cooked to lower water content levels, it will be difficult to remove the oil and acrylamide formation is favored at lower moisture contents. If the potato slices exceed a moisture content of 12% by weight, the desired shape characteristic of the fried food pieces may not be attained and the fried food pieces may cluster together causing difficultly in removing oil and moisture.

In one embodiment, the frying oil in the vicinity of the perforated endless belt conveyor 18 comprises a final temperature of between about 290° F. to about 410° F. and more preferably between about 295° F. to about 320° F. Because the food piece is removed from the oil before it is fully fried, it is referred to as a par-fried food piece. In one embodiment, the pieces after par-frying comprise an oil content of between about 19% and about 40% by weight. It should be noted that using potato slices from potatoes having a high solids content, also reduces the oil absorption in the fryer.

Upon exiting the fryer, surface oil on the par-fried food piece can be absorbed into the par-fried food piece if the par-fried food piece is permitted to cool. Because the gaseous temperature above the frying oil medium above the take-out conveyor is not as hot as the oil temperature, merely exiting the frying oil medium can cause the par-fried food piece to cool.

As shown in FIG. 1, the perforated endless belt conveyor 18 is used to route the bed of fried food pieces through a flow of an inert gas such as superheated steam, nitrogen, carbon dioxide, and combinations thereof. Where the terms steam or superheated steam is used herein, Applicants expressly intend the term to include other inert gases above as well. As used herein, the term “steam” is synonymous with superheated steam, and unless otherwise explicitly stated herein, the term steam does not refer to saturated steam. For purposes of this invention, air is not an inert gas. The superheated steam flow through the bed of the par-fried food pieces is provided by both a positive pressure above the par-fried food pieces by a steam knife 20 and by a negative pressure below said fried food pieces by a steam sweep 30.

A steam pressure source 29 such as a blower or fan can be used to supply steam to the steam knife 20. Similarly, a steam suction source 39 such as a blower or fan can be used to facilitate the flow of superheated steam through a bed of par-fried food pieces.

In one embodiment, the par-fried food pieces are contacted with superheated steam within about 20 seconds more preferably within about 12 seconds and most preferably within about 8 seconds after exiting the hot oil in the fryer. Consequently, the surface oil entry into the par-fried food piece is thereby retarded and the surface oil is removed before the oil has an opportunity to be absorbed into the food piece.

Superheated steam or any other suitable inert gas is preferably used to de-oil the par-fried food pieces instead of hot air because the high flow velocities (e.g., 1000 ft/min to 5000 ft/min) required to de-oil the food pieces will oxidize the food product if air is used. Oxidation can promote staling issues and negatively impact shelf-life. Moreover, the surface oil removed from the par-fried food pieces is often recycled back into the fryer. Air can oxidize this surface oil and use of such surface oil in the fryer is also highly undesirable. In one embodiment, the superheated steam comprises a steam temperature of between about 250° F. and about 330° F. and more preferably between about 290° F. and about 315° F. In one embodiment, the superheated steam temperature is substantially equal (e.g., within about 5° F.) to the exit temperature of the frying oil in the vicinity of the endless belt conveyor to minimize cooling of the food piece and thereby retard and minimize oil absorption and migration into the food piece.

In one embodiment, the velocity of the steam through the par-fried food product bed is at least about 1000 feet per minute and in one embodiment between about 1000 feet per minute and about 5000 feet per minute. However, other flow rates can be used as necessary to remove the desired amount of oil.

In one embodiment, the par-fried food pieces have a dwell time of contact with the steam flow for between about 8 seconds and about 45 seconds. Higher dwell times at moisture contents below 3% by weight can result in undesirably high levels of acrylamide. In one embodiment, a 15 second dwell time can produce a fried potato slice having an oil content of 24% by weight. In one embodiment, the dwell time is controlled by the speed of the perforated endless belt conveyor 18.

In one embodiment, the par-fried food pieces exiting the steam knife/steam sweep comprise an oil content of between about 13% and about 30%. Because of the limited dwell time, the superheated steam contributes very little to moisture removal. Consequently, in one embodiment, the moisture content of the par-fried food pieces exiting the steam knife/steam sweep is between about 2% and about 12%. Because the steam knife/steam sweep does not substantially contribute to the dehydration of the par-fried food pieces, acrylamide formation is advantageously minimized.

As shown in FIG. 1, the pathway utilized by the perforated endless belt conveyor 18 can be covered by a housing 19 to prevent loss of sensible heat from the par-fried slices and to reduce the exposure of the par-fried oil contained therein to oxidative conditions. In one embodiment, the steam knife is partially or fully covered by the housing 19.

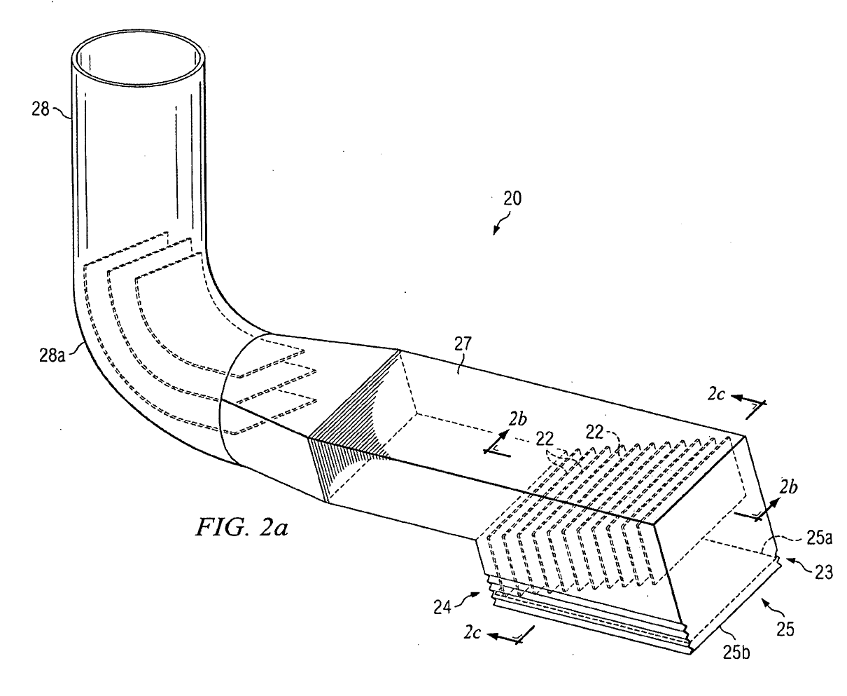

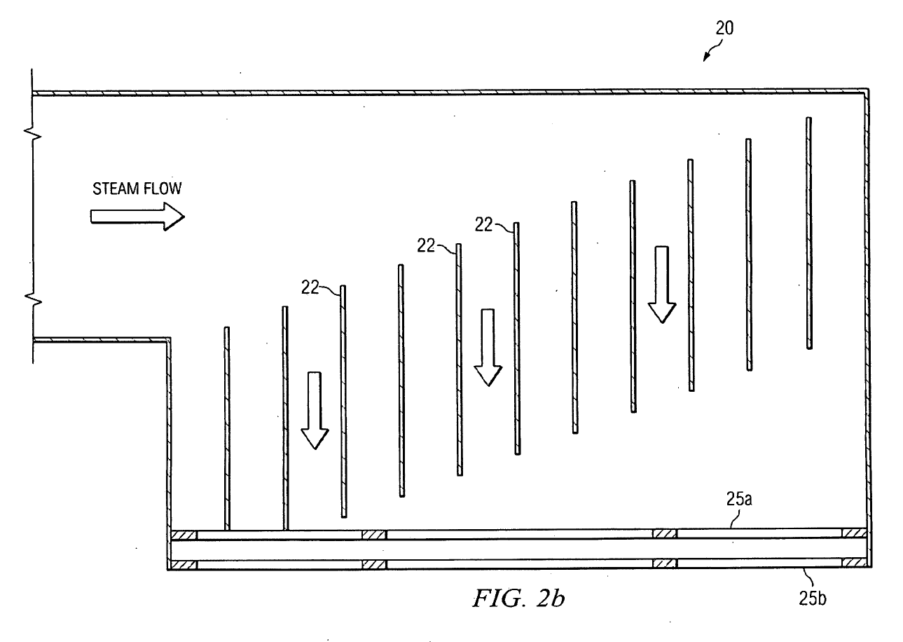

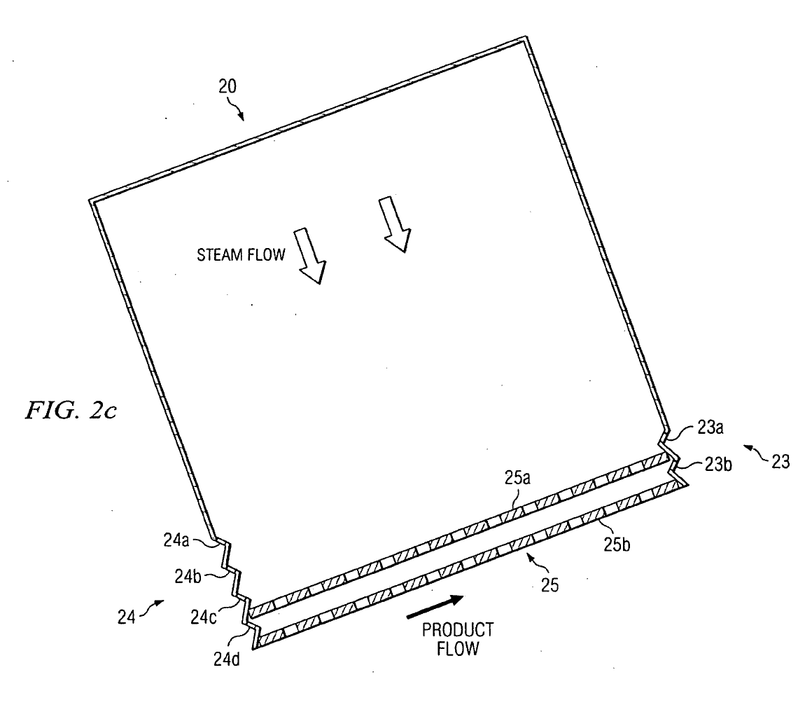

One objective of the present invention is to provide an even blanketed flow of superheated steam over a bed of par-fried food products exiting a fryer. FIG. 2a is a perspective view of the steam knife and associated piping in accordance with one embodiment of the present invention. FIG. 2b is a front cross sectional view of the steam knife depicted in FIG. 2a. Referring to FIGS. 2a and 2b, a round duct 28 exiting the steam pressure source 29 (shown in FIG. 1) transitions, after a rounded corner 28a, into a rectangular duct 27 in communication with the steam knife 20. The affiliated piping between the steam pressure source 29 and the steam knife 20 housing is referred to herein collectively as ductwork. In the embodiment shown, the steam knife 20 comprises a plurality vanes 22 oriented parallel to the direction of the flow of the bed of par-fried product on the endless belt below. As best depicted by FIG. 2b, the vanes 22 are approximately the same length in the vertical direction, but are graduated upward in elevation. The vanes 22 can be constructed of thin sheets of stainless steel or other suitable material. Such configuration advantageously provides an even steam profile across the bed of the par-fried food product below. In one embodiment, the floor of the steam knife 20 comprises one or more perforated plates 25a 25b to further facilitate the even distribution of the steam. In the embodiment shown, the perforated plates 25a 25b each comprise an open area of about 55%. Of course, other suitable open areas can be used.

FIG. 2c is a side view of the steam knife depicted in FIG. 2a. Referring to FIG. 2c, the bed of the par-fried food product moves from left to right. As shown in FIG. 2c, the upstream edge 24 (in relation to the flow of product) of the steam knife 20 housing closest to the oil has a plurality of notches adjacent the bottom edge 25 designated as numerals 24a 24b 24c and 24d. As shown in FIG. 2a, these notches can be fabricated to run the entire length of one side of the steam knife. Referring back to FIG. 2c, in one embodiment, the first three notches 24a 24b 24c each have an open area of 20%. Of course, such number is provided for purposes of illustration and not limitation. Those having ordinary skill in the art, armed with this disclosure, will recognize that other suitable open areas can be used. In one embodiment, the bottom notch 24d has an open area of 30%. Again, other suitable open areas can be used. Similarly, the downstream edge 23b (in relation to the flow of product) comprises two notches 23a 23b adjacent the bottom edge 25. The first notch 23a has an open area of about 45% and the second notch 23b has an open area of about 100%. Again, other suitable open areas can be used. It has been surprising to discover that notches 23a 23b 24a 24b 24c 24d limit the velocity of the steam contacting the bed of par-fried food product just prior to the entry of the bed of par-fried food product into the flow of superheated steam and just after the exit of the bed of par-fried food product from the flow of steam. Limiting the velocity at the entry of the bed of par-fried food product with the upstream notches 24a 24b 24c 24d advantageously prevents steam from forcing par-fried food pieces back into the fryer. The downstream notches 23a 23b can be used to balance the steam flow along the bottom 25 cross-section of the steam knife due to flow exiting through the notches 24a 24b 24c 24d.

Steam knife embodiments other than those depicted in FIGS. 2a-2c can also be used in accordance with the present invention. For example, it is believed that a fluid flow amplifiers based on a fluid dynamic principle referred to as the Coanda Effect can also be used. Such fluid flow amplifiers are available from Exair, Inc. of Cincinnati, Ohio.

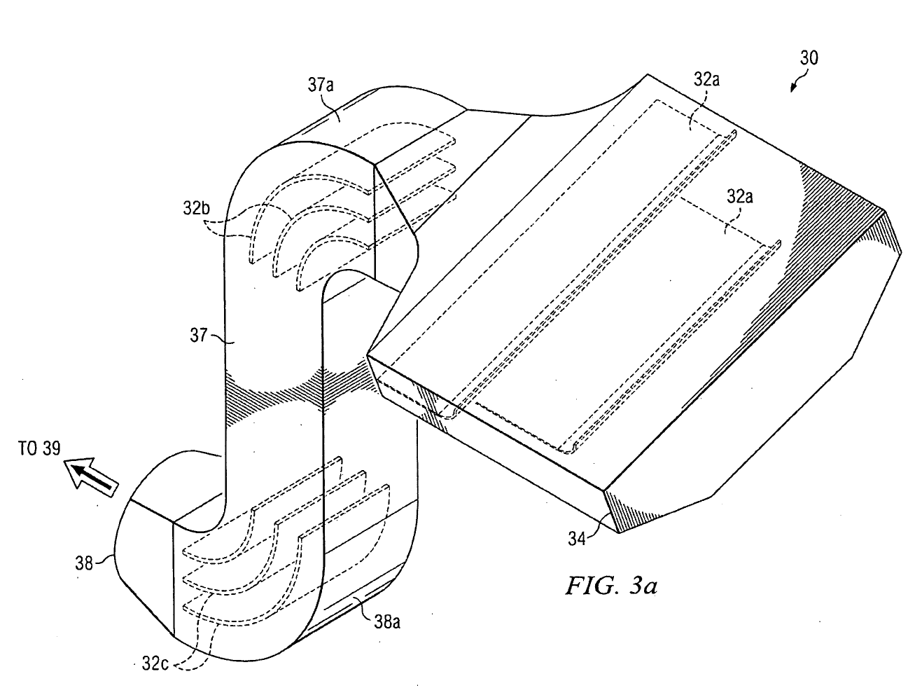

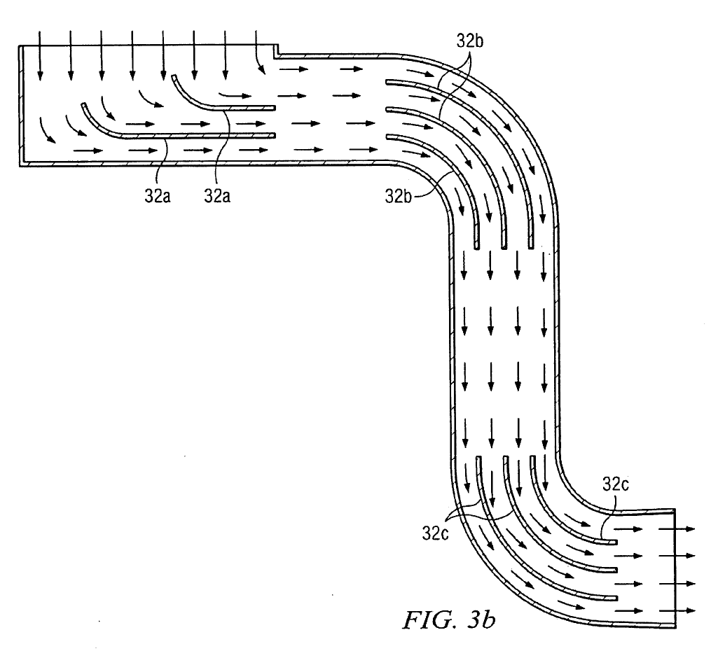

FIG. 3a is perspective view of the steam sweep in accordance with one embodiment of the present invention. FIG. 3b is a cross sectional side view of the steam sweep depicted in FIG. 3a. Referring to FIGS. 3a and 3b, a round duct 38 entering the steam suction source 39 transitions into a rounded rectangular corner 38a in communication with a rectangular duct 37. The rectangular duct is connected to the steam sweep by a second rounded rectangular corner 37a. In the embodiment shown, each rounded rectangular corner 37a 38a comprises a plurality of vanes 32b 32c oriented parallel to the direction of the steam flow. Similarly, the steam sweep 30 comprises a plurality of vanes 32a oriented parallel to the direction of the flow of the steam. Such configuration advantageously reduces pressure drop through the steam sweep and facilitates an even steam profile in the steam sweep duct. For example, use of such vanes and rounded corners as opposed to a square shaped duct having a 90 degree angle results in a higher steam flow rate at a given pressure drop.

As stated above, the sweep provides a negative pressure below the bed of par-fried food pieces, the steam sweep advantageously helps to prevent superheated steam from migrating into the fryer oil. In one embodiment, as shown in FIG. 1, the upstream side 34 of the steam sweep closest to the oil is trapezoidal in shape beneath the conveyor and is as close to the oil as possible to minimize the time the fried food is out of the fryer prior to deoiling, facilitate the capture of superheated steam and further minimize any steam contact with the oil.

In one embodiment, the upstream side 34 of the steam sweep closest to the oil is rectangular in shape beneath the conveyor. In one embodiment, a supply steam actual flow rate through a steam knife is substantially equal to a suction steam actual flow rate through a steam sweep. In another embodiment, a supply steam actual flow rate is less than the suction steam actual flow rate to reduce disturbances to the par-fried food product bed. In one embodiment, the superheated steam knife pressure and/or flow can be controlled independently of the steam sweep flow and/or pressure.

It has been surprisingly found that by using a combination of the steam knife and steam sweep substantially facilitates permeation of the superheated steam through the food product bed on the conveyor. Computer modeling has revealed if a steam knife 20 is used independently without a steam sweep 30 or if the steam knife supply actual flow rate is much greater than the steam sweep suction actual flow rate, the steam from the steam knife does not permeate through the entire depth of the par-fried food product that is bedded on the perforated endless belt conveyor 18. Because the bed depth can range from about 1 inches to 6 inches or even higher, the finding illustrates the drawback of using a steam knife 20 without a steam sweep 30. The bed depth is defined as the shortest distance from the food product closest to the steam knife to the perforated endless belt conveyor 18. Further, the deeper the bed depth, the less opportunity for a steam knife without a steam sweep to contact the par-fried food product exiting the fryer. Moreover, because the superheated steam prevents or retards the cooling of the par-fried food pieces, the additional oil absorption of the surface oil into the par-fried food piece is also retarded. Consequently, the steam functions to both provide heat to the surface of the par-fried food product while simultaneously providing a mechanical stripping action of the surface oil. As shown in FIG. 1, the surface oil removed from the par-fried food product can be routed via a blower 39 to an oil eliminator which can separate the steam and the oil. The oil can then be recycled back to the fryer.

Surface oil on a fried food piece exiting the fryer can go inside the par-fried food, stay on the surface, or can be removed from the surface. Par-frying to higher moisture contents creates an equilibrium such that the moisture in the par-fried food piece prevents and/or retards the penetration or migration of the surface oil into the par-fried food piece. Because of the limited residence time of the bed of food pieces below the steam, moisture reduction is minimized, and the present invention provides a way to prevent or retard surface oil migration into the interior of the food product. Prior art deoilers, on the other hand, simultaneously dehydrate and deoil, which forces the oil into the chip, which limits the amount of deoiling that can occur. Because the par-fried food pieces are deoiled with little dehydration and because temperature strongly influences oil available for removal, the present invention advantageously allows the par-fried food product to be dehydrated at lower temperatures and longer dwell times than permitted in prior art deoilers.

Referring back to FIG. 1, after exiting the steam knife/steam sweep, the deoiled fried food pieces having an oil content of between about 13% and about 30% and a moisture content of about 2% to about 12% enter a dehydration unit 50. The dehydration unit 50 can be of any single or combined conventional drying technology, such as convective air or steam oven, microwave oven, etc. Because there is little or no need for the mechanical stripping forces provided by steam velocity, steam and/or air at velocities between 100 to 2500 ft/min can be used to dehydrate the food product. Consequently, in one embodiment, the dehydration uses hot air having a temperature of less than about 250° F. to dehydrate the deoiled fried food pieces to a moisture content of less than about 2% by weight. In one embodiment, the deoiled fried food pieces are dried in a conventional convective dryer to a moisture content of less than about 2% by weight, and preferably to a moisture content of generally between about 0.8 and 2.0 weight percent. In one embodiment, the dehydration unit 50 uses superheated steam to dehydrate the par-fried deoiled food pieces. In another embodiment, the dehydration unit uses superheated steam to dehydrate the par-fried deoiled food pieces to approximately 2 to 3% moisture by weight and then a conventional convective dryer uses hot air to dehydrate the par-fried deoiled food pieces to less than about 2% moisture by weight. In one embodiment, the de-oiled potato slices exit the dehydration unit 50 with an oil content of between about 17% to about 30%. In one embodiment, de-oiled tortilla chips exit the dehydration unit 50 with an oil content of between about 13% to about 19%. In one embodiment, de-oiled corn chips exit the dehydration unit 50 with an oil content of between about 28% to about 30% by weight.

The de-oiled and dehydrated food pieces exit the dehydrating unit 50 and advance into a tumbler 60 wherein salt and/or seasonings may be added to the food pieces. The seasoned food pieces exit the tumbler 60 on a conveyor belt 62 and are transferred to a packaging area not shown in the figure where the products are prepared for shipment.

Hence, the present invention is able to simultaneously reduce both the oil content and acrylamide level of fried foods without sacrificing the organoleptical properties in a much more economical manner. For example, the steam knife and steam sweep can be added to existing systems without substantial increase in the footprint required for the equipment.

It should be pointed out that while some embodiments of the present invention are directed towards a potato slice embodiment; other embodiments can be used in accordance with the spirit and scope of the present invention. Consequently, where potato slices are referred to herein, Applicants mean to include any sliced, cut or whole fruit or vegetable which can be fried. Further, the present invention can also be applied to dough-based embodiments and fabricated food products including, but not limited to, corn chips and tortilla chips. For example, a corn chip or a tortilla chip exiting a fryer can be contacted with a flow of superheated steam provided by a steam knife and a steam sweep as described above and the food product can be subsequently finished dried as described above.

While this invention has been particularly shown and described with preferred embodiment, it will be understood by those skilled in the art that various changes and form detail may be made therein without departing from the spirit and scope of the invention.

What is claimed is:

1. A method for producing a low oil fried food product, said method comprising the steps of:
a) frying a food product in hot oil having a hot oil temperature of at least 280° F. until said slices have a moisture content of about 2% to about 12% by weight thereby providing a plurality of par-fried food pieces;
b) removing said par-fried food pieces from said hot oil;
c) contacting said par-fried food pieces with a flow of an inert gas selected from one or more inert gases comprising superheated steam; nitrogen, carbon dioxide, and mixtures thereof; wherein said flow is provided by a positive pressure above said fried food pieces and by a negative pressure below said fried food pieces to make a plurality of de-oiled food pieces.

2. The method of claim 1 wherein said inert gas comprises superheated steam.

3. The method of claim 1 wherein said contacting at step c) occurs within 12 seconds of said removing at step b).

4. The method of claim 1 wherein said positive pressure is routed through ductwork wherein said ductwork further comprises a plurality of vanes.

5. The method of claim 1 further comprising a steam knife housing having at least one edge wherein said edge further comprises at least one notch having an open area along said edge.

6. The method of claim 1 wherein said negative pressure is provided by a steam sweep, wherein said steam sweep comprises a plurality of vanes.

7. The method of claim 1 wherein said contacting at step c) occurs for a residence time of between about 8 and about 45 seconds.

8. The method of claim 1 wherein said velocity of inert gas is between at least about 1000 feet per minute.

9. The method of claim 1 wherein a supply gas actual flow rate through a steam knife is less than a suction gas actual flow rate through a steam sweep.

10. The method of claim 1 wherein said fried food pieces after step c) comprise an oil content of between about 13% and about 30% by weight.

11. The method of claim 1 further comprising:
d) dehydrating said deoiled fried food pieces in an air dryer to a moisture content of less than about 2% by weight.

12. The method of claim 1 further comprising:
d) dehydrating said deoiled fried food pieces to a moisture content of less than about 2% by weight.

13. The method of claim 1 wherein a supply gas actual flow rate through a steam knife is substantially equal to a suction gas actual flow rate through a steam sweep.

14. The method of claim 1 wherein a supply gas actual flow rate through a steam knife is controlled independently of a suction gas actual flow rate through a steam sweep.

15. The method of claim 1 wherein a supply gas pressure is controlled independently of a suction gas pressure through a steam sweep.

16. An apparatus for deoiling fried food products, said apparatus comprising:
a fryer having a perforated endless belt conveyor exiting said fryer, said conveyor having a top belt and a bottom belt;
a steam knife positioned above said endless belt conveyor; and
a steam sweep positioned beneath said top belt.

17. The apparatus of claim 16 wherein said steam knife further comprises a plurality of vanes.

18. The apparatus of claim 17 wherein said vanes substantially the same length.

19. The apparatus of claim 17 wherein said vanes are graduated upward in elevation.

20. The apparatus of claim 16 wherein said steam knife further comprises at least one edge wherein said edge further comprises at least one notch having an open area along said edge.

21. The apparatus of claim 20 wherein said edge comprises an upstream edge further comprising at least four notches, wherein each notch has an open area of at least about 20%.

22. The apparatus of claim 20 wherein said edge comprises a downstream edge further comprising at least two notches wherein each notch has an open area of at least 40%.

23. The apparatus of claim 16 wherein said steam knife further comprises steam knife ductwork and wherein said ductwork comprises a rectangular duct in communication with said steam knife.

24. The apparatus of claim 16 wherein said steam knife further comprises a floor having at least one perforated plate.

25. The apparatus of claim 16 wherein said steam knife further comprises a fluid flow amplifier.

26. The apparatus of claim 16, wherein said steam knife is covered by a housing.

27. The apparatus of claim 16 wherein said steam sweep further comprises a plurality of vanes.

28. The apparatus of claim 16 wherein said steam sweep comprises a trapezoidal shape beneath said conveyor.

29. The apparatus of claim 16 wherein said -steam sweep further comprises a plurality of vanes.

30. The apparatus of claim 16 wherein said steam sweep further comprises ductwork having one or more rounded rectangular corners.

31. The apparatus of claim 16 wherein said steam knife further comprises ductwork having one or more rounded rectangular corners.
